(19) United States
(12) Patent Application Publication
(10) Pub. No.: US 2010/0019115 A1
(43) Pub. Date: Jan. 28, 2010

(54) BEVERAGE SUPPORT WITH ADJUSTABLE GRILL ATTACHMENT HOOKS

(76) Inventor: WERNER K. SCHIMMEYER, Cameron Park, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/573,826

(22) Filed: Oct. 5, 2009

Related U.S. Application Data
(63) Continuation-in-part of application No. 12/419,224, filed on Apr. 6, 2009.
Application No. 12/419,224 is a continuation-in-part of application No. 11/732,791, filed on Apr. 4, 2007.

(51) Int. Cl. B60N 3/10; A47G 29/093

(52) U.S. Cl. 248/311.2

(57) ABSTRACT

A holder for supporting a beverage container against an automobile air conditioner/heater grill includes a housing having a base for holding a beverage container bottom, and open top surrounding the beverage container sides, an open back and upstanding sidewalls inner connecting the base and the open top. Sidewalls include an open front for enabling passage of air therethrough and circulation of air around the container sides. An elastic member interconnecting the sidewalls and spanning the open back and a grill engagement member includes a grill hook at a distal end and a fitting at an opposite end for slidably engaging the elastic member.

The present application is a continuation-in-part of U.S. Ser. No. 12/419,224 filed Apr. 6, 2009, which is a continuation-in-part of U.S. Ser. No. 11/732,791 filed Apr. 4, 2007 and these referenced patent applications are to be incorporated herein in their entirety by this specific reference thereto.

The present invention generally relates to a holder for supporting a beverage container for receiving air from an automobile heating and cooling system and more particularly directed to a positionable beverage holder for enabling convenient positioning of the beverage holder with respect to and in front of an automobile dashboard vent for enabling optimal cooling and heating of a beverage container supported by the holder and supporting/holding a cell phone in a convenient location with the automobile.

Beverage holders for mounting on the dashboard or other positions within an automobile are generally well known.

For example, U.S. Patent No. Des. 226,623, 2,289,701, and 2,294,151 show a holder for a beverage container for use against a door panel or the like. U.S. Des. 338,138 discloses a container holder for securing to the dashboard vent of an automobile as do U.S. Des. 342,192 and U.S. Des. 342,869.

The various beverage holders developed have the common purpose of supporting a beverage container in a stationary position, preferably for receiving heating or cooling from the dashboard, while freeing both hands of the driver and passengers in order to not only to enable safe operation of the automobile, but minimizing the possibility of spillage during vehicle maneuvers. See for example U.S. Pat. No. 6,560,983 to Schimmeyer.

While these designs are useful for providing beverage container support, they do not optimize or facilitate positioning of the beverage holder in front of the dashboard air conditioning/heating vents in order to provide optimum heating and/or cooling of the beverage container supported by the holder.

Heretofore, designed holders required reattachment of the holder to the vent in order to reposition the holder in front of the vent. In this regard, optimum positioning may not be attainable because of discrete positioning of vent ribs that is necessary for coupling the beverage holder to the grill.

Other devices provide for permanently attaching supporting alms to the vent and means for adjusting the position of the beverage holder in front of the vent. However, each of these devices require positioning and coupling of the holder with attached arms in order to effect a proper position. Further, most of these devices enable only discrete positions against the grill, or vent, and this does not optimize the positioning of the holder in front of the dashboard vent.

The present invention provides for a holder for supporting a beverage container that provides for support a beverage container in a general vertical position against either vertically oriented grill vanes and horizontally oriented grill vanes.

### SUMMARY OF THE INVENTION

A holder for supporting a beverage container against an automobile air conditioner/heater grill and also supporting a cell phone, generally includes a housing with a beverage container bottom holding base, an open top surrounding the beverage container sides, an open back and upstanding walls connecting the base of the open top.

The sidewalls include an open front for enabling passage of air therethrough and circulation of air around the container sides.

A plurality of adjustable pins protrude from the housing back and adjustment of the protrusion of the pins from the housing back enables abutment with non-vertical grills with the housing top in a generally horizontal plane and the beverage being held in a generally vertical orientation.

An elastic member interconnects the upstanding sidewalls and spans the open back and at least one grill engagement member is provided which has adjustable length portion. The member includes a grill hook at a distal end and an elastic band engagement fitting at a proximal end.

The adjustable length portion increases the compatibility of the holder in accordance with the present invention for various grill designs and further enables control over engagement pressure between the grill and the holder.

A plurality of grill engagement members may be provided, for example, two, and each of the engagement member fittings is slidably fixed to the elastic member for adjusting spacing between the engagement members along the elastic member. This structure further facilitates the compatibility of the holder in accordance with the present invention with grills of practically any size, shape, and orientation as will be hereinafter described in greater detail.

The adjustable length portion of the engagement member is provided by a threaded shaft and a threaded nut engaging the shaft at the fitting end of the member. Rotation of the nut causes adjustment of the length of the member portion.

An elongate nut engaging toot is provided for coupling with the nut and rotation thereof through the housing open face thus providing insitu adjustment of the member portion length and engagement force between the holder and the grill.

The tool also enables orientation of the hook for facilitating engagement with either a horizontal grill vane or a vertical grill vane.

A sidewall opening enables the detachable engagement of a cell phone.

### BRIEF DESCRIPTION OF THE DRAWINGS

The advantages and features of the present invention will be better understood by the following description when considered in conjunction with the accompanying drawings, in which:

FIG. 1 is a perspective view of one embodiment of a holder in accordance with the present invention as it may be installed against the air conditioning grill of an automobile and also showing in perspective a driver ready access to either the beverage container or a cell phone supported by the holder;

FIG. 2 is a perspective view of the holder shown in FIG. 1 in accordance with the present invention for supporting a beverage container against an automobile air conditioner/heater grill generally showing a housing and a plurality of adjustable pins protruding from a housing back;

FIG. 3 is a cross sectional side view of the holder shown in FIG. 1 as it may be installed against an air conditioning grill through the use of adjustable protruding pins;

FIG. 4 is a top view of the holder shown in FIGS. 2 and 3 as it may be installed against an air conditioner grill further showing an elastic member for encircling the housing sidewalls along with grill engagement hooks fixed to opposite ends of the elastic member as well as a cell phone holder detachably received by upstanding housing sidewalls;

FIG. 5 is a side cross sectional view, taken along the line 5-5 of FIG. 4, illustrating removable attachment of the cell phone holder to the housing; and

FIG. 6 is a perspective view of another embodiment of a holder in accordance with the present invention;

FIG. 7 is a cross sectional view of the holder shown in FIG. 6 as it may be installed against an air conditioning grill through the use of hooks on an elastic member;

FIG. 8 is a top view of the holder shown in FIGS. 6 and 7 as it may be installed against an air conditioner grill further illustrating an elastic member spanning the housing open back;

FIG. 9 is an enlarged view of the hooks engaging the elastic member and an assembly rod for facilitating attaching of the hooks to a grill;

FIG. 10 is a cross sectional view of the hook and elastic member with the assembly rod engaged with the hook;

FIG. 11 is a perspective view of yet another embodiment of a holder in accordance with the present invention;

FIG. 12 is an elevation view of the embodiment shown in FIG. 11;

FIG. 13 is a cross sectional view of the embodiment shown in FIG. 12 taken along the line 13-13 illustrating orientation of hooks for engagement with horizontally oriented grill vanes; and

FIG. 14 is a view taken along the lines 14-14 of FIGS. 11-13 illustrating orientation of hooks for engagement with vertically oriented grill vanes.

### DETAILED DESCRIPTION

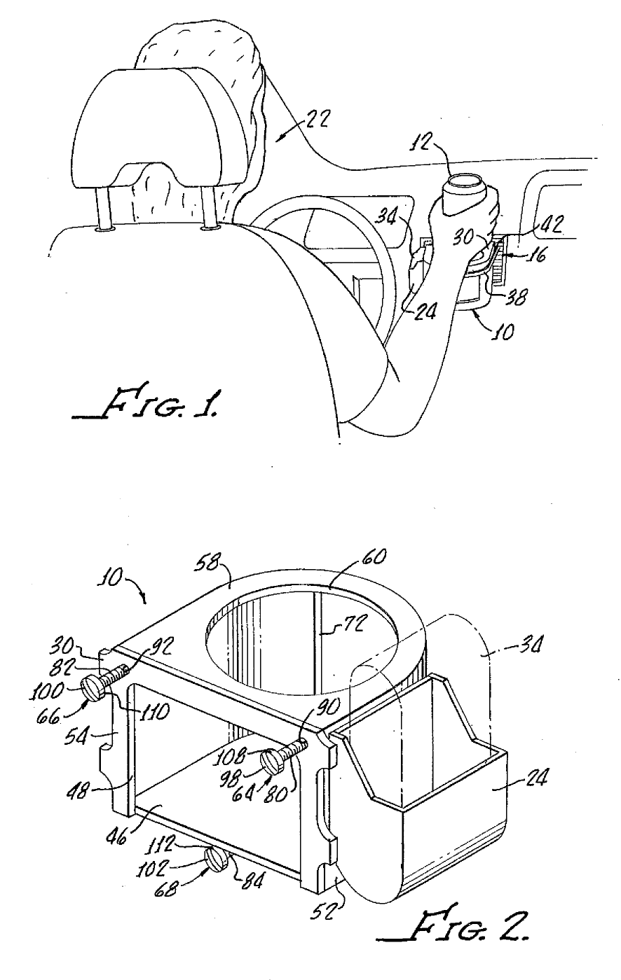

With reference to FIG. 1, there is shown a first embodiment of a holder 10 in accordance with the present invention for supporting a beverage container 12 positioned against an automobile air conditioner/heater grill 16 for ready access by a driver 22.

As will be hereinafter described in greater detail, a cell phone holder 24 may be detachably disposed on a holder housing 30 for cradling a cell phone 34 also at a position for convenient access by the driver 22.

An elastic member 38 surrounding the housing engages the grill 16 via grill engagement hooks 42.

As more clearly shown in FIG. 2, the holder 10, housing 30 includes a beverage container bottom holding base 46, an open back 48, upstanding sidewalls 52, 54 connecting the base 46 and a top 58 with an opening 60 for receiving the beverage container 12, not shown in FIG. 2.

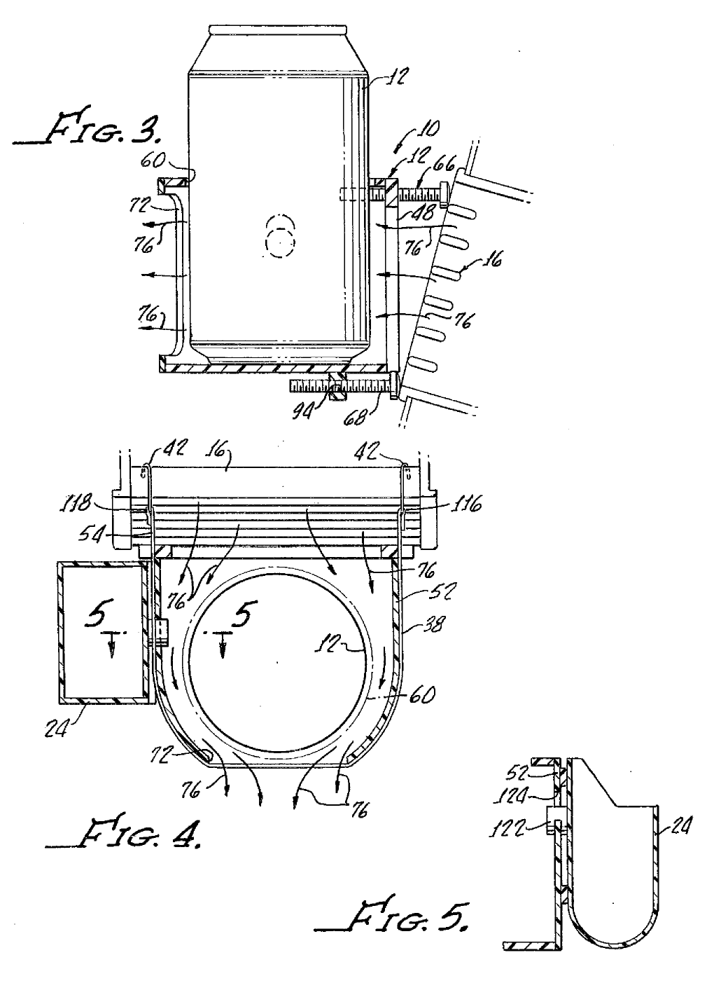

A plurality of protruding pins 64, 66, 68 extending from the housing back 48 enable abutment of the housing 12 with a non-vertical grill 16 by adjustment of protrusion of the pins 64, 66, 68 as illustrated in FIG. 3. A triangular pattern of the pins 64, 66, 68 provides stability.

The open back 48 and a front opening 72 enable passage of air through the housing 12 and encircling a beverage container 12 as illustrated by the arrows 76 in FIGS. 3 and 4. The housing 30 may be formed from any suitable plastic material and molded with the open back 48 and front opening 72.

Each of the pins 64, 66, 68 include threaded shanks 80, 82, 84 which are received by threaded bores 90, 92, 94 respectively in the housing back 48.

Preferably, each pin 64, 66, 68 includes a non-slip head 98, 100, 102 disposed at a protruding end of each pin 64, 66, 68 respectively. The heads 98, 100, 102 are sized to prevent intrusion into the grill 16 and to stabilize the housing 12 there against.

The housing is stabilized or held against the grill by the elastic member 38 as best illustrated in FIG. 4 in which hooks are provided at ends 116, 118 of the elastic member 38.

As best shown in FIG. 4, the elastic member 38 passes between the housing 35 and the cell phone holder 24 for enabling the cell phone holder to be attached to either side 52, 54 of the housing 30.

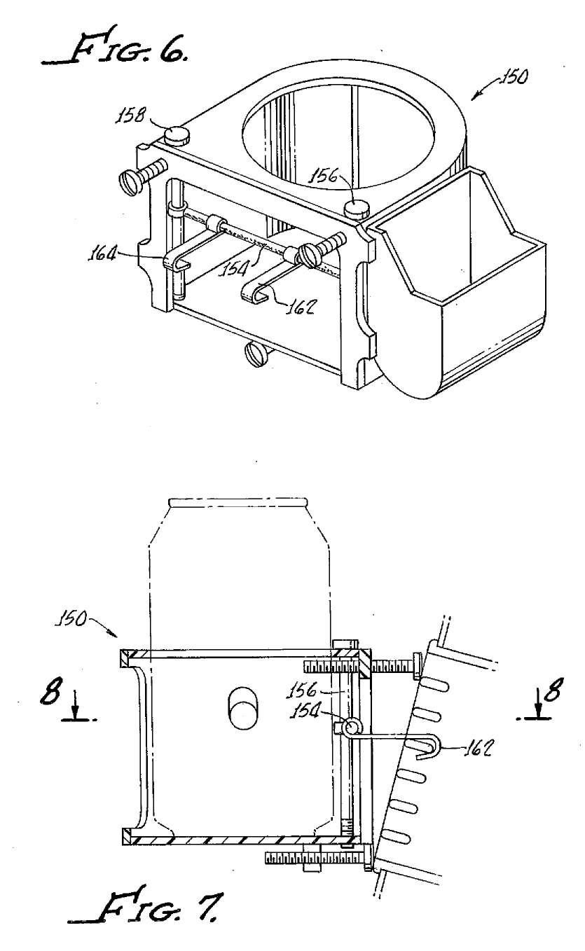

As illustrated in FIG. 5, which is a cross sectional view taken along the line 5-5 of FIG. 4, the cell phone holder 24 includes a molded bracket for engaging a sidewall opening 124 which enables the cell phone holder 24 to be detachably received by the housing upstanding sidewalls 52, 54.

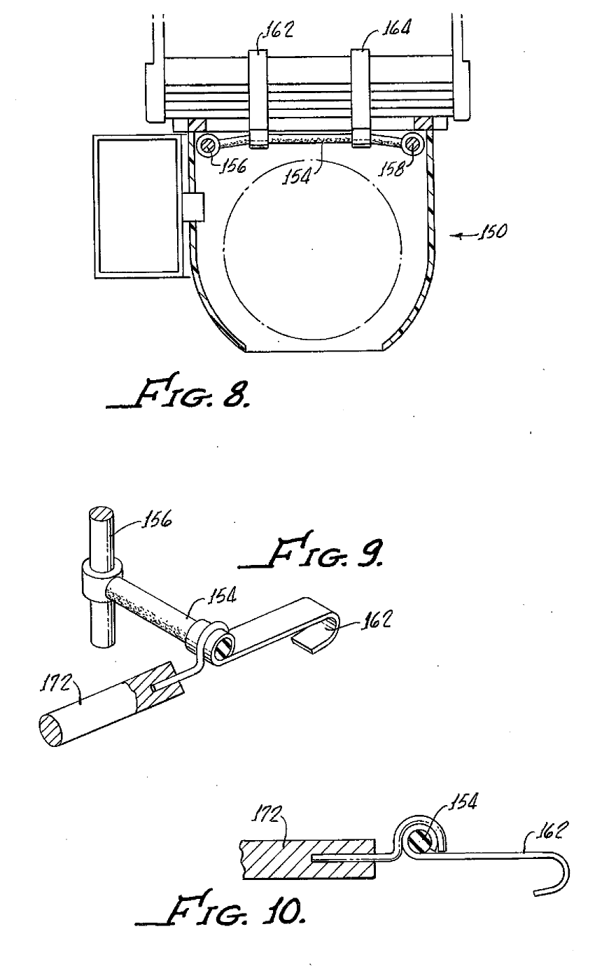

With reference now to FIGS. 6-10, there is shown a second alternative embodiment of a holder 150 in accordance with the present invention. In these figures, common reference characters refer to elements identical to or substantially similar to elements shown in connection with the description of the holder 10 shown in FIGS. 1-5.

In his embodiment, an elastic member 154, supported by posts 156, 158, spans the housing open back 48 and includes a pair of spaced apart grill attachment hooks 162, 164 attached to the elastic member 154.

More particularly shown in FIGS. 6, 8, and 9, the hooks 162, 164 are slidably attached to the elastic member 154 for enabling change in spacing between the hooks 162, 164 which enables the holder 150 to be attached to very narrow grills, not shown.

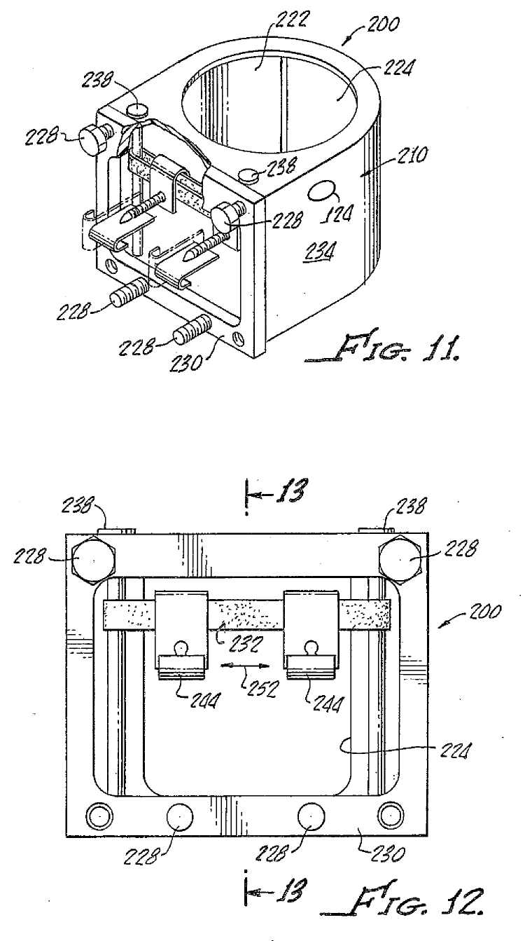

As also shown in FIGS. 9-10, an assembly rod 172 is provided for engaging the hooks 162, 164 and enabling attachment of the hooks 162, 164 to the grill 16.

Other structural features of the holder 150 are described hereinbefore with regard to the holder 10.

With reference now to FIGS. 11-14, there is shown a third embodiment of a holder 200 in accordance with the present invention for supporting a beverage container 204 against an automobile air conditioner/heater grill 208. Common reference characters refer to elements identical to or substantially similar elements shown in connection with the description of the holder 10 shown in FIGS. 1-5.

The holder 200, which may be formed from any suitable material, generally includes a housing 210 which includes a beverage container bottom 212 holding base 214, an open top 216 surrounding beverage container sides 218 along with a front 222 having an opening 224 which enables passage of air therethrough and circulation of air around the container sides 218.

A plurality of adjustable pins 228 protruding from an open back 230. The pins 228, being threaded, enable adjustment of the protrusion thereof from the housing back 230 which, in turn, enables abutment with a non-vertical grill with the housing top 216 in a general horizontal orientation as illustrated in FIG. 13.

An elastic member 232 interconnects the sidewalls 234 by attachment to pins 238 with the elastic member 232 spanning the open back 230 as shown in FIGS. 11-14. At least one grill engagement member 240 includes an adjustable length portion 242, a grill hook 244, disposed at a member distal end 246, and a fitting 248 disposed at a member proximal end 250.

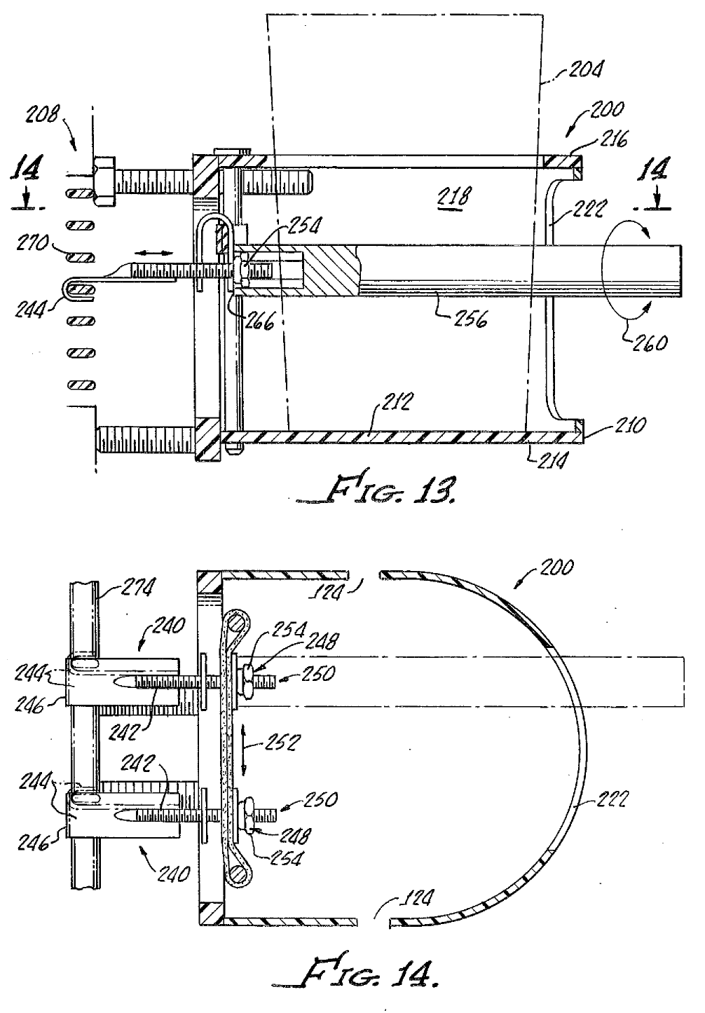

The fittings 248 slidably engage the elastic member 232 for enabling the adjustment of spacing indicated by the arrow 252 in FIGS. 12 and 14.

With particular reference to FIGS. 13 and 14, the fitting 248 includes a nut 254 and a tool 256 is provided for removably coupling with the nut 254 through the housing open face 222 for enabling a rotation as indicated by the arrow 260 and rotation of the nut 254 for adjustment of the engagement member length as indicated by the arrow 264 in FIG. 13. A head 266 of the tool 256 is configured for engagement with the nut.

Importantly, rotation of the tool 256 along with the nut 254 and member 240 enables orientation of the hook 244 horizontally as shown in FIG. 13 for engagement horizontally disposed grill vanes 270 or in a vertically enabling engagement with vertically disposed grill vanes 274 as shown in FIG. 14.

Although there has been hereinabove described a specific holder for a beverage container in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A holder for supporting a beverage container against an automobile air conditioner/heater grill, said holder comprising:
a housing having a beverage container bottom holding base, an open top surrounding beverage container sides, an open back and upstanding sidewalls connecting the base and open top, the sidewalls having an open front enabling passage of air therethrough and circulation of air around the container sides;
a plurality of adjustable pins protruding from the housing back, adjustment of protrusion of the pins from the housing back enabling abutment with a non-vertical grill with the housing top in a generally horizontal plane;
an elastic member interconnecting said upstanding sidewalls and spanning said open back; and
at least one grill engagement member, having an adjustable length portion, the member having a grill hook at an engagement member distal end and an elastic band engagement fitting at engagement member proximal end.

2. The holder according to claim I further comprising two grill engagement members, each engagement member having an adjustable length portion, a grill hook at an engagement member distal end, and an elastic band engagement fitting at an engagement member proximal end.

3. The holder according to claim 2 wherein the fitting of each engagement member is slidably fixed to said elastic member for adjusting spacing between the engagement members along said elastic member.

4. The holder according to claim 1 wherein the engagement member comprises a threaded shaft and the fitting comprises a threaded nut engaging the shaft with rotating of the nut causing adjustment of the length of the member portion.

5. The holder according to claim 4 wherein the hook is fixed to the engagement member distal end and orientable between a horizontal orientation for engagement with horizontal grill vanes and a vertical orientation for engagement with vertical grill vanes.

6. The holder according to claim 1 further comprising an elongate nut engaging tool for removably coupling with the nut, through the housing open face, and enabling rotation of the nut thereby adjusting the member portion length.

7. The holder according to claim 1 wherein the plurality of adjustable pins includes three adjustable pins spaced apart from one another in a triangular relationship on the housing back.

8. The holder according to claim 1 further comprising a sidewall opening enabling detachable engagement of a cell phone.

9. A holder for supporting a beverage container against an automobile air conditioner/heater grill, said holder comprising:
a housing having a beverage container bottom holding base, an open top surrounding beverage container sides, an open back and upstanding sidewalls connecting the base and open top, the sidewalls having an open front enabling passage of air therethrough and circulation of air around the container sides;
a plurality of adjustable pins protruding from the housing back, adjustment of protrusion of the pins from the housing back enabling abutment with a non-vertical grill with the housing top in a generally horizontal plane;
an elastic member interconnecting said upstanding sidewalls and spanning said open back; and
at least two grill engagement members, each having an adjustable length portion, each engagement member having a grill hook at an engagement member distal end and an elastic band engagement fitting at an engagement member proximal end.

10. The holder according to claim 9 wherein the fitting of each engagement member is slidably fixed to said elastic member for adjusting spacing between the engagement member along said elastic member.

11. The holder according to claim 9 wherein each engagement member comprises a threaded shaft and each fitting comprises a threaded nut engaging the shaft with rotation of the nut causing adjustment of the length of each member portion.

12. The holder according to claim 11 wherein each hook is fixed to a corresponding engagement member distal end and orientable between a horizontal orientation for engagement with horizontal grill vanes and a vertical orientation for engagement with vertical grill vanes.

13. The holder according to claim 9 further comprising an elongate nut engaging tool for removably coupling with each nut, through the housing open front, and enabling rotation of each nut thereby adjusting each member portion length.

14. The holder according to claim 9 wherein the plurality of adjustment pins includes three adjustment pins spaced apart from one another in a triangular relationship on the housing back.

15. The holder according to claim 9 further comprising a sidewall opening enabling detachable engagement of a cell phone.
